(19) United States
(12) Patent Application Publication
(10) Pub. No.: US 2026/0141328 A1
(43) Pub. Date: May 21, 2026

(54) SYSTEMS AND METHODS FOR TECHNICAL DEBT RISK MANAGEMENT USING ARTIFICIAL INTELLIGENCE

(71) Applicant: TEACHERS INSURANCE AND ANNUITY ASSOCIATION OF AMERICA, New York, NY (US)

(72) Inventors: Sastry Vsm Durvasula, Phoenix, AZ (US); Swatee Singh, Livingston, NJ (US); Rares Ioan Almasan, PHOENIX, AZ (US); Sonam Jha, Skillman, NJ (US); Thomas Matthew Verutes, Rockville Centre, NY (US); Sriram Venkatesan, Princeton Junction, NJ (US); Geeta Pyne, San Jose, CA (US); Vaughn Alliton, Ocean, NJ (US)

(21) Appl. No.: 18/952,523

(22) Filed: Nov. 19, 2024

(51) Int. Cl. G06Q 10/0635; G06F 40/40

(52) U.S. Cl. CPC G06Q 10/0635; G06F 40/40

(57) ABSTRACT

Systems and methods for detecting, classifying, and predicting a risk severity and/or likelihood from technical debt within an organization are disclosed. An example system obtains input data including internal organization information, third-party tool information, operational risk management information, previous technical debt assessments, previous asset rationalizations, and business capability information. The system processes the input data using a combination of neural networks, generative artificial intelligence models, and reinforcement learning with human feedback. The system generates the risk from technical debt based on the processing, and generates an output of risk information associated with the risk from technical debt.

### FIELD OF THE INVENTION

The present aspects relate to systems and methods for managing technical debt within an organization, and more particularly, to detecting, classifying, and predicting risk severity and/or likelihood from technical debt using a combination of neural networks, generative artificial intelligence models, and reinforcement learning with human feedback.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Technical debt has become increasingly recognized as a critical factor that can significantly impact the operational efficiency, security, and financial health of organizations. As software systems evolve, technical debt accumulates, which, if not managed properly, can lead to increased maintenance costs, diminished performance, and reduced agility in responding to market changes. Despite its significance, many organizations struggle with identifying, classifying, and managing technical debt effectively due to the lack of standardized methodologies and tools.

The integration of third-party tools and services introduces additional layers of complexity in managing technical debt. These external components can bring their own set of risks and dependencies, making it challenging to assess the overall risk posture of an organization's technical infrastructure. Moreover, the dynamic nature of technology, with frequent updates and changes, necessitates a more proactive and predictive approach to managing technical debt. The lack of effective tools for predicting future risks associated with technical debt further complicates this issue, leaving organizations vulnerable to potential failures and security breaches.

Given the challenges in identifying, classifying, and predicting risks associated with technical debt, there are therefore opportunities for improved platforms and technologies for solving the identified conventional problems.

### BRIEF SUMMARY OF THE INVENTION

Generated In one aspect, a computing system for detecting, classifying, and predicting a risk severity and/or likelihood from technical debt within an organization includes: (1) a processor; and (2) a memory having stored thereon computer-executable instructions that, when executed, cause the computing system to: (a) obtain input data including internal organization information, third-party tool information, operational risk management information, previous technical debt assessments, previous asset rationalizations, and business capability information; (b) process the input data using a combination of neural networks, generative artificial intelligence models, and reinforcement learning with human feedback; (c) generate the risk severity and/or likelihood from technical debt based on the processing; and (d) generate an output of risk information associated with the risk severity and/or likelihood from technical debt.

In another aspect, a computer-implemented method for detecting, classifying, and predicting a risk severity and/or likelihood from technical debt within an organization includes: (1) obtaining, via one or more processors, input data including internal organization information, third-party tool information, operational risk management information, previous technical debt assessments, previous asset rationalizations, and business capability information; (2) processing, via a combination of neural networks, generative artificial intelligence models, and reinforcement learning with human feedback, the input data; (3) generating, via the one or more processors, the risk severity and/or likelihood from technical debt based on the processing; and (4) generating, via the one or more processors, an output of risk information associated with the risk severity and/or likelihood from technical debt.

In yet another aspect, a non-transitory computer-readable medium includes instructions that when executed by one or more processors, cause the one or more processors to: (1) obtain input data including internal organization information, third-party tool information, operational risk management information, previous technical debt assessments, previous asset rationalizations, and business capability information; (2) process the input data using a combination of neural networks, generative artificial intelligence models, and reinforcement learning with human feedback; (3) generate a risk severity and/or likelihood from technical debt based on the processing; and (4) generate an output of risk information associated with the risk severity and/or likelihood from technical debt.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 a block diagram of an exemplary computing environment 100 in which methods and systems for detecting, classifying, and predicting a risk from technical debt within an organization are implemented, according to embodiments.

FIG. 2 depicts a block diagram of an example computer-implemented method for detecting, classifying, and predicting a risk from technical debt within an organization, according to embodiments.

FIG. 3 depicts a block flow diagram of an example computer-implemented method for codifying internal information, according to embodiments.

FIG. 4 depicts a block flow diagram of an example computer-implemented method for codifying external information, according to embodiments.

FIG. 5 depicts a block flow diagram of an example computer-implemented method for codifying risk management information, according to embodiments.

FIG. 6 depicts a block flow diagram of an example computer-implemented method for defining business capabilities, according to embodiments.

FIG. 7 depicts a block flow diagram of an example computer-implemented method for detecting, classifying, and predicting technical debt risk, according to embodiments.

FIG. 8 depicts a block flow diagram of an example computer-implemented method for providing outputs associated with detecting, classifying, and predicting technical debt risk, according to embodiments.

FIG. 9 depicts a computer-implemented method 900 for detecting, classifying, and predicting risk from technical debt within an organization, according to embodiments.

FIG. 10A depicts a block flow diagram of an example computer-implemented method 1000 for training and/or operating a language model, according to embodiments.

FIG. 10B depicts a block diagram of an example neural network-based model architecture for processing and analyzing data related to technical debt risk, according to embodiments.

### DETAILED DESCRIPTION

In the rapidly evolving landscape of technology, organizations are tasked with the continuous challenge of innovating while efficiently managing their technological infrastructure. Achieving a balance between these objectives is crucial for maintaining competitiveness, agility, and the ability to swiftly adapt to market changes. However, organizations often encounter the significant hurdle of technical debt, which includes issues such as suboptimal design, outdated code, inadequate infrastructure, security vulnerabilities, and inefficient data management. These challenges not only hinder the productivity of development teams but also pose risks such as system failures, security breaches, and disruptions, adversely affecting business operations and end-user experiences. Traditionally, assessing an organization's risk of technical debt has been a complex, expensive, and time-consuming process.

Addressing these challenges, the disclosed systems and methods provide a comprehensive approach to identify, classify, and predict technical debt risk, enabling an organization to proactively manage and mitigate the impacts of technical debt. The disclosed techniques obtain input data internal and external to an organization's technology ecosystem to provide a holistic view of the technical landscape and the inherent risks posed by technical debt. The input data may include internal organization information, third-party tool information, operational risk management information, previous technical debt assessments, previous asset rationalizations, and business capability information. The disclosed system and methods may process the input data using a combination of neural networks, generative artificial intelligence models, and reinforcement learning with human feedback to generate the risk from technical debt, and output risk information associated with the risk from technical debt.

The aspects of the claims result in a practical application that effectively solves the aforementioned prior art problems through the use of AI to automate the detection, classification, and prediction of technical debt, coupled with its ability to incorporate human feedback for continuous learning and adjustment. The assessment of technical debt risk allows an organization to proactively understand and manage existing and potential technical debt, optimizing their technology investments and reducing the overall cost of the software development lifecycle. Additionally, improving suboptimal design, updating outdated code, revising inadequate infrastructure, patching security vulnerabilities, and improving data management based upon the risk of technical debt are all benefits that flow from the present techniques.

Another significant improvement is the optimization of network usage. The system's ability to remotely access and analyze data from code repositories and application architecture diagrams minimizes the need for extensive data transfers, thereby reducing network load. This efficient use of network resources is particularly beneficial for organizations with distributed teams and cloud-based infrastructures, ensuring that the assessment of technical debt does not disrupt other operations.

Furthermore, disclosed techniques offer significant improvements in how organizations can manage technical debt. By providing a dynamic and interactive output of technical debt risk information via a dashboard, a chatbot, and/or notifications, a user gains insights into technical debt risks and their impacts on business functions. The outputs ensure relevant information is readily accessible to those who need it, facilitating informed decision-making.

In summary, the disclosed systems and methods represents a significant advancement in the field of technical debt risk management. By leveraging AI along with a comprehensive data gathering approach, the systems and methods offer robust solutions for detecting, classifying, and predicting risks associated with technical debt. The benefits of improved processing, network, and memory usage, combined with informative outputs of technical debt risk information provide a valuable tool for organizations seeking to proactively manage and mitigate the risks of technical debt.

### Example Computing Environment

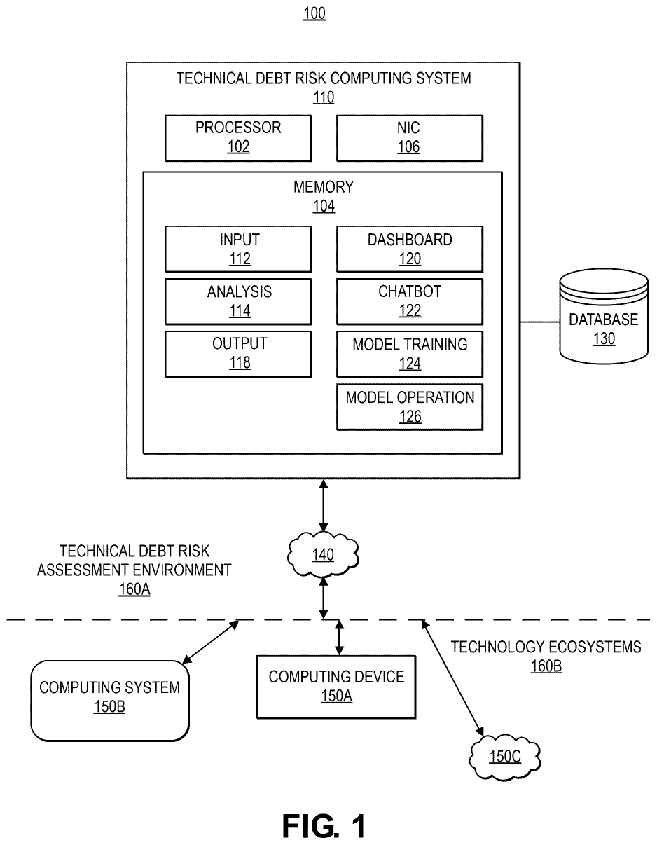

FIG. 1 depicts a block diagram of an exemplary computing environment 100 in which methods and systems for detecting, classifying, and predicting a risk severity and/or likelihood from technical debt within an organization are implemented, according to embodiments. The computing environment 100 may include a technical debt risk computing system 110 of a technical debt risk assessment environment 160A communicatively coupled via a network 140 to one or more computing devices 150A, computing systems 150B, and/or a computing networks 150C of technology ecosystems 160B.

The technical debt risk computing system 100 may include a processor 102, a memory 104, and a network interface controller (NIC) 106. The processor 102 may include any number of processors and/or processor types, such as central processing units (CPUs), graphics processing units (GPUs), field-programmable gate arrays (FPGAs), application-specific integrated circuits (ASICs), digital signal processors (DSPs), neural processing units, RISC-V processors, coprocessors, specialized processors/accelerators for artificial intelligence (AI) or machine learning (ML)-specific applications, one or more microcontrollers, and the like. Generally, the processor is configured to execute instructions stored in the memory 104.

The memory 104 may include volatile and/or non-volatile fixed and/or removable memory, such as read-only memory (ROM), electronic programmable read-only memory (EPROM), random access memory (RAM), erasable electronic programmable read-only memory (EEPROM), and/or other hard drives, flash memory, solid-state drives, optical drives, MicroSD cards, and others. The memory 104 may have stored thereon one or more sets of processor-executable instructions.

The memory 104 may include a plurality of modules, each module comprising a respective set of processor-executable instructions. An input module 112 may obtain input data from multiple sources, including internal organization information, third-party tool information, operational risk management information, previous technical debt assessments, previous asset rationalizations, and business capability information. An analysis module 114 may utilize neural networks, generative artificial intelligence models, reinforcement learning with human feedback, and/or other models or data processing techniques, to generate the confidentiality, integrity and availability risk from technical debt based on analyzing or otherwise processing the input data. An output module 118 may generate one or more outputs of risk information associated with the risk of technical debt, such as technical debt risk insights to explain the risk derived from the availability of computing capabilities and integrity of the output and business rule processing from technical debt. A dashboard module 120 may output, display, and/or otherwise provide risk information via an electronic dashboard, such as risk information specific to one or more business processes that are reliant on respective technologies and/or components. A chatbot module 122 may include a chatbot for interactive queries related to the business risk impacts, including the likelihood or severity from technical debt.

A model training module 124 and a model operation module 126, respectively, train and operate machine learning models, such as neural networks, generative AI models, and language models (LMs). The model training module 124 prepares the machine learning models by using historical data and patterns related to technical debt risk, ensuring that the models are well-equipped to recognize and evaluate technical debt risk, such as technical debt risk associated with information technology (IT), interruptions to business operations from older technology, etc. For example, the model training module 124 may train one or more machine learning models (e.g., one or more language models, one or more neural networks, etc.) using training data including historical information from various sources, such as historical information from code repositories, diagrams, and documents. The training data used for training one or more machine learning models may include historical input data such as internal organization information, third-party tool information, operational risk management information (e.g., internal and industry incident impacts caused by technical debt, technical debt assessments, asset rationalizations, and business capability information. The training process may involve preprocessing the training data to ensure it is in a format suitable for analysis, followed by the application of machine learning techniques, including neural networks, deep learning algorithms, and reinforcement learning with human feedback. The architecture of the machine learning model may be based on neural networks and generative AI models. The model operation module 126 may apply trained models using the computing environment 100 (e.g., the technical debt risk computing system 110) to provide real-time analysis and insights into technical debt risk (e.g., probability and impact calculations).

The technical debt risk computing system 110 may employ one or more models (e.g., a combination of models, a multimodal model, etc.) to process images (e.g., diagrams) and text (e.g., documents), extracting relevant information and classifying the information into categories such as by asset or tool. One or more evaluation metrics of the models and/or the technical debt risk computing system 110 system may be used to continuously improve the performance of the technical debt risk computing system 110 and/or models. The metrics may be associated with the accuracy of technical debt risk identification, classification, and/or prediction.

In some aspects, the model training module 124 may pre-train a model and/or fine-tune a model. In some aspects, such pre-training and/or fine-tuning may be performed using a cloud platform/API such as Large Language Models (LLMs) fine-tuning of a commercially-available model such as OpenAI's GPT (Generative Pre-trained Transformer). LMs can assist in generating code, generating reports, interpreting complex data sets, and summarizing technical documents, among other things. The LMs can enhance productivity, improve code quality, and accelerate the development cycle of AI models for technical debt risk assessment. This technical stack, enriched with LM capabilities, represents a foundation for effectively managing the challenges associated with assessing and addressing technical debt risk within a technology ecosystem and/or organization.

The NIC 106 may include any suitable network interface controller(s), such as wired/wireless controllers (e.g., Ethernet controllers), and facilitate bidirectional/multiplexed networking over the network between the computing environment 100 and other components or systems. The network may be a single communication network or may include multiple communication networks of one or more types (e.g., one or more wired and/or wireless local area networks (LANs), and/or one or more wired and/or wireless wide area networks (WANs) such as the Internet).

The technical debt risk computing system 110 may include, and/or be communicatively coupled to (e.g., via the network 140), at least one electronic database 130. The database 130 may include a relational database, such as Oracle, DB2, MySQL, a NoSQL database such as MongoDB, and/or another other suitable database. The database 130 may store various types of information to determine, classify, and/or predict technical debt risk. The database 130 may store internal organization information (e.g., code repositories, asset details, asset diagrams, or asset documents), third-party tool information (e.g., third-party asset documents, integration patterns, release and patch strategies, or data, compliance, and governance strategies), operational risk management information (e.g., operational risk categories such as Confidentiality, Integrity and Availability impacting the reliability of automated business processes and/or the protection of sensitive personal information or intellectual property, risk management documents, industry risk incident data and information, strategy and insights, or operational risk management reports), previous technical debt assessments, previous asset rationalizations, business capability information (e.g., business process diagrams, business documents, business strategies, or business capability reports), neural networks, generative AI models, machine learning model, risk information, and/or any other suitable information.

The network 140 may communicatively couple components and/or devices of the computing environment 100. The network 140 may include both physical and virtual components that together enable the transmission of data throughout the computing environment 100. The physical components of the network 140 may include one or more servers that store and process data, routers and switches that direct data traffic, and cabling and/or wireless technology infrastructure that links these devices. The virtual components of the network 140 may include software such as network operating systems, network management tools, and communication protocols that ensure data is transmitted securely and arrives at its intended destination within the computing environment 100. The network 140 may enable user interaction with the computing environment 100 through various interfaces, such as applications, dashboards, chatbots, etc., allowing the user to input data, configure settings, and view outputs like reports and dashboards (e.g., via one or more APIs (not depicted)).

The computing environment 100 may be logically divided to include a technical debt risk assessment environment 160A, and one or more technology ecosystems 160B, according to embodiments. The technical debt risk assessment environment 160A may include the technical debt risk computing system 110 and its components. The technology ecosystems 160B may include one or more components that are evaluated for technical debt risk. The one or more technology ecosystems 160B may include one or more computing devices 150A, one or more computing systems 150B, and/or one or more computing networks 150C. Of course, the one or more technology ecosystems 160B may include more or fewer (or different) components, such as operating systems, applications, and development tools that enable devices to perform tasks and provide functionality to users; network infrastructure including local area networks (LAN), wide area networks (WAN), the internet, and wireless networks; data that is processed, stored, and transmitted by the computing ecosystem, including databases, data warehouses, and big data platforms; security components such as encryption software/devices, firewalls, and antivirus software; /oud/ remote servers and services that provide scalable computing resources, storage, and applications over the internet; middleware such as APIs and message brokers/queues; user interfaces including graphical user interfaces (GUIs), command-line interfaces (CLIs), and voice interfaces; hardware and solutions for saving data, such as hard drives, solid-state drives (SSDs), network-attached storage (NAS), and cloud storage; integration services; support/maintenance services including technical support, software updates, and hardware maintenance; and standards and protocols. Any of the foregoing devices, services, networks, etc. may contribute to technical debt risk.

One or more components of the computing environment 100 may be implemented as cloud-based services. For example, the electronic database 130 may be hosted on a cloud platform such as Amazon Web Services (AWS), Google Cloud Platform (GCP), or Microsoft Azure, leveraging scalable storage solutions and managed database services like Amazon RDS or Google Cloud SQL. This cloud-based implementation allows for dynamic scaling to accommodate varying loads and data volumes, ensuring that the system can efficiently handle the extensive data analysis required for determining, classifying and predicting technical debt risk and/or incidents, such as specific control failures, the cost to recover and resume operations after an incident, etc. Additionally, merely for example, the model training module 124 and the model operation module 126 may utilize cloud-based machine learning and AI services, such as AWS SageMaker or Google AI Platform, to train and deploy sophisticated models for identifying and mitigating technical debt. A cloud-based approach may provide the flexibility and computational power needed to process large datasets and apply complex algorithms, enhancing the system's ability to deliver real-time insights and recommendations. It should be appreciated that the computing environment 100 may utilize a public cloud, such as AWS, GCP, or Azure, to leverage their infrastructure and services for scalability and flexibility. Alternatively, a private cloud may be employed, offering more control over the environment and potentially enhanced security for sensitive data related to technological debt risk. A hybrid cloud approach may also be adopted, combining the benefits of both public and private clouds by keeping certain critical operations and data on-premises or in a private cloud for security and compliance reasons, while utilizing the public cloud for scalable computing resources and advanced services. A hybrid model may provide a balanced approach, optimizing the system's performance and security based on the specific needs for determining, classifying and predicting technical debt risk (e.g., the risk of incidents caused by technical debt).

In operation, the computing environment 100 detects, categorizes and/or predicts technical debt risk within a technology ecosystem (e.g., technology ecosystem 160B). The technical debt risk computing system 110 may obtain input data via the input module 112. The technical debt risk computing system 110 may obtain the input data from one or more local sources (e.g., the memory 104, the database 130) and/or remote sources (e.g., via the 140) such as one or more remote databases 130, computing devices 150A, one or more computing systems 150B, and/or any other suitable source of input data.

The input data may include internal organization information, third-party tool information, operational risk management information (e.g., the sensitivity of business processes to the integrity and availability of automation which may be impacted based on the extent of the technical debt), previous technical debt assessments, previous asset rationalizations, business capability information, and/or any other input data that may be suitable for determining, classifying and/or predicting incident impacts and likelihood where driven by the existence of technical debt that would increase the probability of those incidents to occur and the length of time and amount of resources required to recover from said incidents.

The internal organization information may include and/or be associated with information internal to an organization, such as internal business processes useful in assessing a risk of technical debt incidents, including and/or associated with code repositories, asset details (e.g., computing assets), asset diagrams (e.g., computing system diagrams), and/or asset documents.

The third-party tool information may include and/or be associated with vendor tools (e.g., software applications) used by an organization and the associated technical debt risk therefrom. The third-party tool information may include third-party asset documents, integration patterns (e.g., associated with the impact of integrating new or updated software), release and patch strategies, and/or data, compliance, and governance strategies (e.g., to ensure compliance with regulatory standards). There is further risk that a third party to the vendor (e.g., fourth party) may have reliance on technology that may be a driver of incidents due to their own technical debt.

The operational risk management information may include and/or be associated with information from business risk management team assessments and identification of sensitivity of the business operations to the technology supporting the reliable execution of critical business functions respective to different technical debt risk categories at the organization level, potential risks based on industry standards, industry experts thought processes, shared incident data including details on control failures, etc. The operational risk management information may include operational risk categories, risk management documents, industry risk incident data and information (quantitative and qualitative), strategy and insights, or operational risk management reports.

The previous technical debt assessments are detailed in U.S. patent application Ser. No. 18/889,583, entitled “ANALYSIS AND CLASSIFICATION METHODS AND SYSTEMS FOR ASSESSING, IDENTIFYING, AND TRACKING TECHNICAL DEBT IN ORGANIZATIONS” filed on Sep. 19, 2024, and herein incorporated by reference in its entirety. The previous technical debt assessments may assess technical debt within a technology ecosystem (e.g., of an organization) and identify areas for technical debt improvement. The previous technical debt assessments may include actionable strategies based on the assessment of technical debt, such as a detailed report of technical debts by applications, a report of technical debts by business functions, an interactive chatbot for stakeholder engagement, and a dashboard for visualizing tech debt data and progress in addressing identified debts, etc.

The previous technical debt rationalizations are detailed in U.S. patent application Ser. No. __,___,___; entitled “SYSTEM, METHOD, AND COMPUTER-READABLE MEDIUM FOR ASSESSING AND RATIONALIZING TECHNICAL DEBT USING AI AND MACHINE LEARNING ANALYSIS WITH MULTI-SOURCE DATA INTEGRATION” filed on __/__/____ and hereby incorporated by reference in its entirety. The previous technical debt rationalizations may include one or more actions for asset rationalization of software and hardware assets. The previous technical debt rationalizations may include detailed reports, process diagrams, and artificial intelligence-enabled videos to explain one or more steps for asset rationalization, etc.

The business capability information may include and/or be associated with information regarding business processes, such as business processes associated with technical debt. The business capability information may be based upon one or more business process diagrams, business documents, business strategies, or business capability reports.

The technical debt risk computing system 110 may process or otherwise analyze the input data to generate the risk from technical debt via the analysis module 114. The risk from technical debt may be indicated using one or more metrics, values, scores, and/or other indicators.

The data collected is analyzed to evaluate operational procedures of technology ecosystems 160B, assess the technical foundation of the system, incorporate and evaluate governance information, analyze the technical environment to understand its impact, etc. The analysis module 114 may incorporate industry knowledge when evaluating the technical debt risk posed by the organization technology environment. The output of the intelligent assessment module 116 provides an understanding of the detected and predicted technical debt risks. The analysis module 114 may generate detailed reports of technical debts by application, business function, etc. The output of the analysis module 114 may enable informed decision-making and strategic planning for mitigating technical debt. Each module within the system contributes to the execution of the method for determining, classifying, and predicting technical debt risk within a technical environment.

The analysis module 114 may use or otherwise employ one or more neural networks, generative artificial intelligence models, reinforcement learning with human feedback, and/or other suitable models and/or data processing techniques to process or otherwise analyze the input data. In at least some aspects, one or more neural networks may (i) classify the internal operational information by asset; (ii) classify the third-party tool information by third-party tool based upon receiving third-party tool information; (iii) classify the operational risk management information by risk category; (iv) classify the business capability information by business function; (v) determine technical debt risk; (vi) classify technical debt risk by risk or control category; and/or predict potential risk impacts from the existence of technical debt. In at least some aspects, one or more generative AI models may generate one or more reports associated with internal information, third-party vendor tools, operational risk management, and/or business capabilities.

The technical debt risk computing system 110 may generate, via the output module 118, an output of risk information associated with the risk impacts due to the existence of technical debt. The technical debt risk computing system 110 may output at least a portion of the risk information at an electronic dashboard via the dashboard module 120. The dashboard may be dynamically generated, provide information on identified technical debt risk categories or aligned with specific control expected to fail or have reduced effectiveness in reducing the impact when an incident occurs, their impacts, affected business functions, severity, etc. The technical debt risk computing system 110 may provide or otherwise employ a chatbot via the chatbot module 122 for providing user interaction respective to queries related to the risk from technical debt. The chatbot may provide the user detailed information associated with the technical debt risk. The technical debt risk computing system 110 may generate one or more notifications and/or tasks associated with the risk from technical debt via the output module 118. The technical debt risk computing system 110 may provide (e.g., via the dashboard) or otherwise transmit (e.g., via the network 140 to a computing device 150A) the notifications and/or tasks to one or more cross functional teams.

In operation, the interaction with the computing environment 100 may vary significantly between end users and administrative users, each engaging with the system in ways that align with their roles and responsibilities in managing technological debt prioritized by the risk values identified. For end users, their interaction primarily revolves around accessing and utilizing the outputs generated by the technical debt risk computing system 110, such as accessing detailed reports, utilizing interactive chatbots, and viewing dashboards visualizing technical debt risk information. These tools are designed to provide end users with insights into the technical debt risk landscape, enabling them to understand the severity and impact of technical debt within their organization that could drive action based on the business processes expected to be impacted when the risk becomes an incident.

In operation, end users can direct the computing environment 100 to analyze specific components or aspects of technical debt risk within a technology ecosystem 160B, focusing on particular ecosystem computing devices 150A, ecosystem computing systems and services 150B, and/or ecosystem computing networks 150C. This targeted analysis allows end users to gain detailed insights into the technical debt risk associated with specific areas of their technological infrastructure, enabling more precise identification and prioritization of issues that need to be addressed. To initiate this focused analysis, an end user may interact with user interfaces of one or more devices of the computing environment 100, which may include a web portal, a desktop application, a mobile app, etc. Through this interface, the user can specify the components or aspects of technical debt risk they wish to analyze. This may involve selecting from a list of available ecosystem components, such as operating systems, applications, development tools, network infrastructure, databases, security components, cloud services, middleware, user interfaces, storage solutions, integration services, support/maintenance services, and standards and protocols. The user may also have the option to define custom components or aspects of the tech ecosystem that are of particular concern or interest (e.g., by typing in an IP address or other address enabling a zero configuration mechanism).

Potential actors using the computing environment 100 could include application owners, risk management teams, cybersecurity teams, enterprise resiliency groups and other cross-functional teams within an organization. These actors interact with the computing environment through various computing devices or systems, which may be individual servers, a cluster of multiple servers, laptops, desktop computers, or cloud-based virtualization services. These devices or systems are connected to the computing environment 100 via the network, enabling the seamless exchange of data and insights.

Further operation of the computing environment 100 is included in the following description of motivating use cases. It should be appreciated that other use cases are contemplated.

### Example Method for Detecting, Classifying, and Predicting Risk Type, Severity or Likelihood From Technical Debt

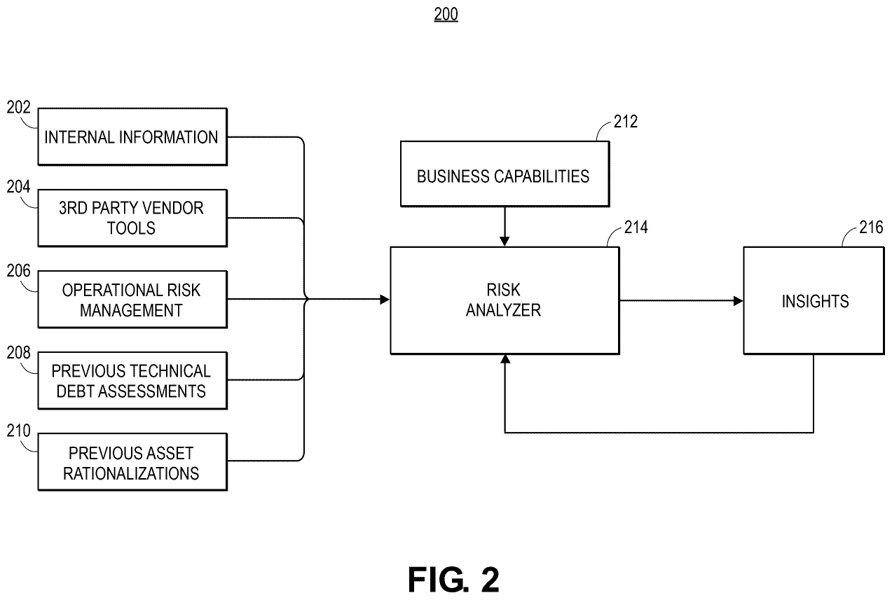

FIG. 2 depicts a block diagram of an example computer-implemented method 200 for detecting, classifying, and predicting a risk from technical debt within an organization, according to embodiments. The method 200 may include processing internal information (block 202), third-party tool information (block 204), operational risk management information (block 206), and business capability information (block 212). Gathering a wide range of data may ensure a holistic view of the organization's technical ecosystem. For example, internal organization information could include details from code repositories and asset documents, providing a deep dive into the technical assets owned by the organization.

The method 200 may obtain the combined input data from blocks 202, 204, 206, 208, 210 and 212. The method may perform a risk analysis (block 214) on the combined input data to detect, classify, and predict risk impacts from technical debt. The method 200 may include generating technical debt risk insights (block 216).

The input information received enables the method 200 to analyze and understand process information, technology information, governance information, and inputs from other blocks that contribute to a comprehensive understanding of the technical ecosystem. The inclusion of operational information allows the method 200 to consider the dynamic nature of operational structures. By integrating the input information, the method 200 can provide information associated with technical debt risks, ensuring that the strategies devised are aligned with the organization's objectives and parameters.

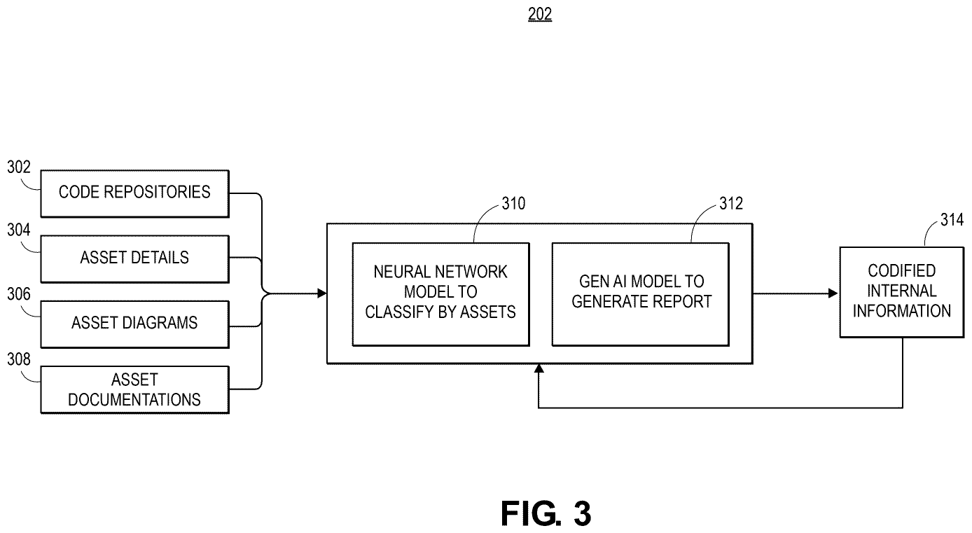

FIG. 3 depicts a block flow diagram of an example computer-implemented method 202 for codifying internal information, according to embodiments. The method 202 generally corresponds to block 202 of the method 200 of FIG. 2. The method 202 may process internal information and generate reports using artificial intelligence. The method 202 may include receiving internal information inputs including code repositories (block 302), asset details (block 304), asset diagrams (block 306), and asset documents (block 308). A neural network may receive the internal information from blocks 302, 304, 306 and 308 and in response classify the third-party vendor information by asset (block 310). Following the classification, the method 202 may include generating one or more reports by a generative AI model (block 312), resulting in codified internal information (block 314).

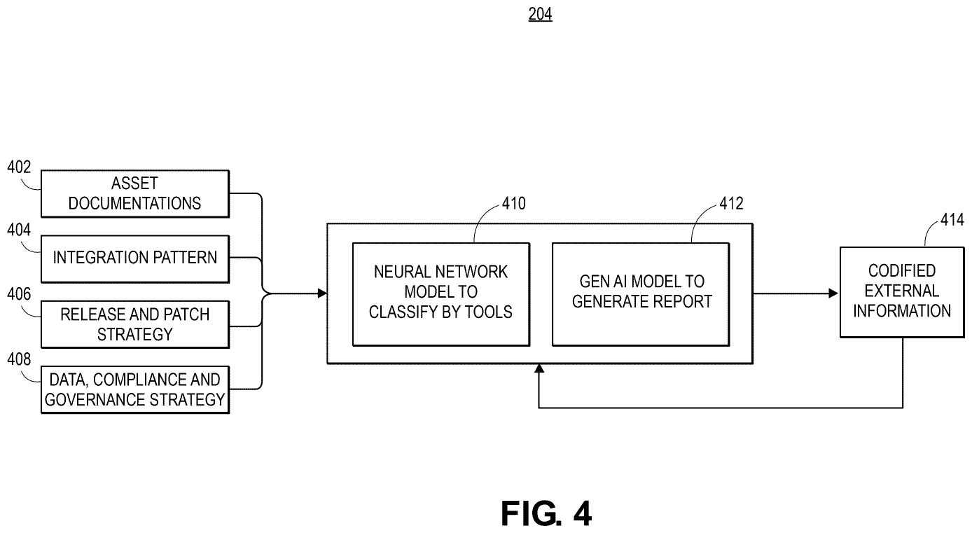

FIG. 4 depicts a block flow diagram of an example computer-implemented method 204 for codifying external information, according to embodiments. The method 204 generally corresponds to block 204 of the method 200 of FIG. 2, according to aspects. The method 204 may process third-party vendor information and generate reports using artificial intelligence. The method 204 may include receiving the third-party tool information including asset documents (block 402), integration patterns (block 404), release and patch strategies (block 406), and data, compliance, and governance strategies (block 408). A neural network may receive the third-party vendor information from blocks 402, 404, 406 and 408 and in response classify the third-party vendor information by tool (block 410). Following the classification, the method 204 may include generating one or more reports by a generative AI model (block 412), resulting in codified external information (block 414).

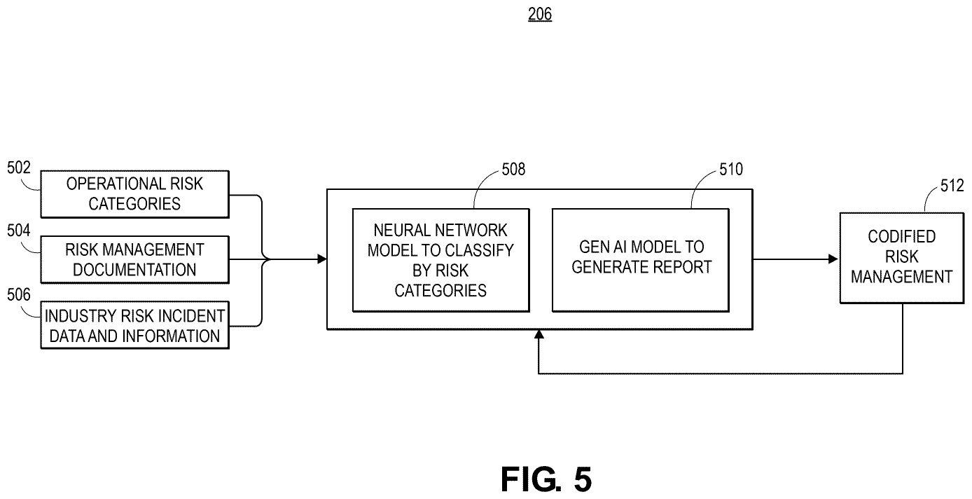

FIG. 5 depicts a block flow diagram of an example computer-implemented method 206 for codifying risk management information, according to embodiments. The method 206 generally corresponds to block 206 of the method 200 of FIG. 2. The method 206 may process operational risk management information and generate reports using artificial intelligence. The method 206 may include receiving the operational risk management information including operational risk categories (block 502), risk management documents (block 504), and industry risk data and information including incident trends and expected impacts, strategy and insights (block 506). A neural network may receive the operational risk management information from blocks 502, 504, and 506 and in response classify the operational risk management information by risk and/or control category (block 508). Following the classification, the method 206 may include generating one or more reports by a generative AI model (block 510), resulting in codified risk management information (block 414).

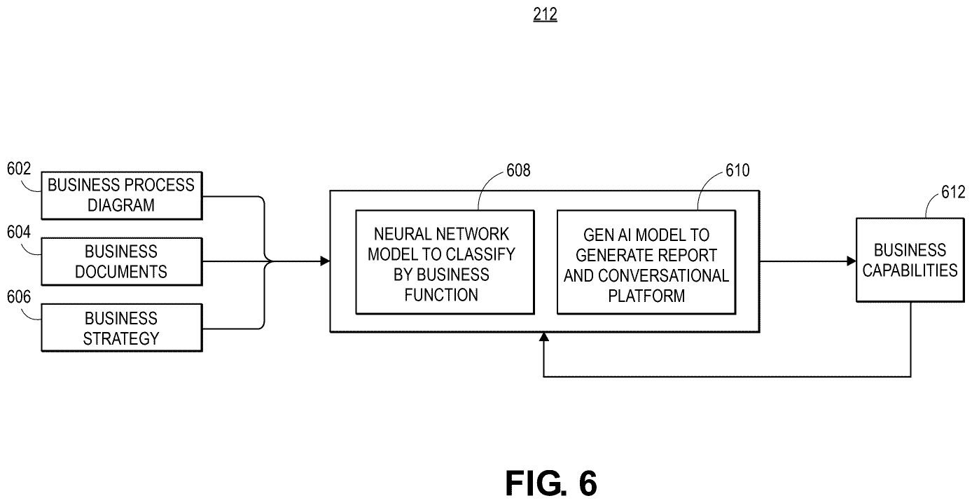

FIG. 6 depicts a block flow diagram of an example computer-implemented method 212 for defining business capability information, according to embodiments. Method 212 generally corresponds to block 212 of the method 200 of FIG. 2. The method 212 may determine business capabilities of an organization, according to some aspects. The method 212 may include generating and/or receiving business capability information including one or more business process diagrams (block 602), business documents (block 604), and business strategies (block 606). A neural network model may receive and classify the business capability information by business function (block 608). A generative AI model may generate one or more reports and/or provide a conversational platform (block 610). The method 212 may conclude with defining business capabilities (block 612). In at least some embodiments, the sensitivity of the business processes and/or functions may be related to the accuracy and reliability of the automation for completing one or more activities.

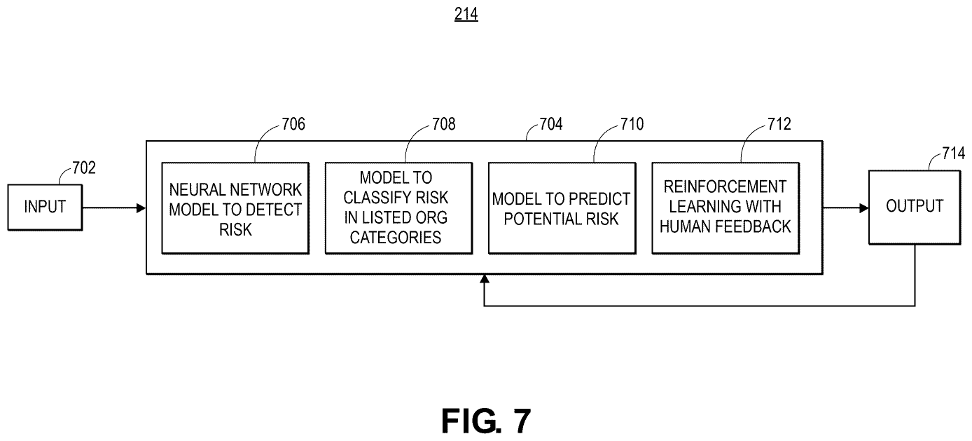

FIG. 7 depicts a block flow diagram of an example computer-implemented method 214 for detecting, classifying, and predicting technical debt risk (likelihood and severity of impact), according to embodiments. Method 214 generally corresponds to block 214 of the method 200 of FIG. 2. The method 214 may generate risk from technical debt (e.g., via the analysis module 114). The method 214 may include receiving input (block 702), such as the codified internal information, the codified external information, the codified risk management, the previous technical debt assessments, previous asset rationalization, and the business capability information. The method 214 may include processing the input (e.g., via the analysis module 114) by via: (i) at least one neural network to detect technical debt risk (block 706), (ii) at least one model to classify technical debt risk by organizational category (block 708), and (iii) at least one model to predict technical debt risk sensitivity (block 710). Processing the input (block 704) may include employing reinforcement learning with human feedback (block 712). The method 214 may conclude with generating the output (block 714) (e.g., risk information via the output module 118).

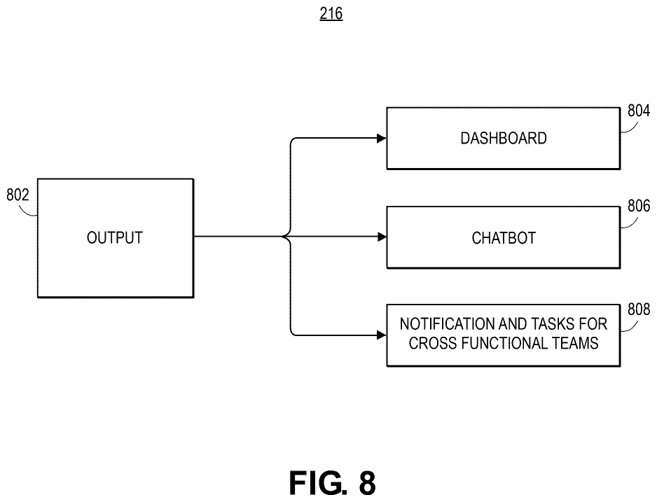

FIG. 8 depicts a block flow diagram of an example computer-implemented method 216 for providing outputs associated with detecting, classifying, and predicting technical debt risk, according to embodiments. The method 216 generally corresponds to block 216 of the method 200 of FIG. 2. The method 216 may output risk information at dashboard (block 804) (e.g., via the dashboard module 120). The method 216 may provide a chatbot (block 806) (e.g., via the chatbot module 122). The method 216 may output (e.g., via the output module 118) one or more notifications and/or tasks for cross-functional teams (block 808).

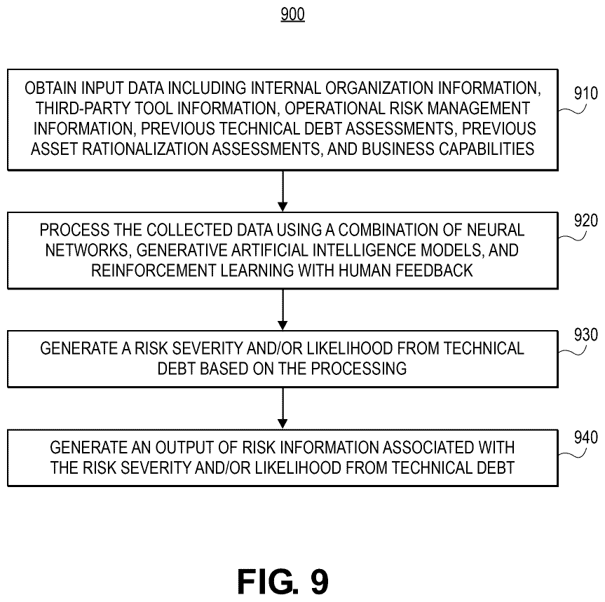

FIG. 9 depicts a computer-implemented method 900 for detecting, classifying, and predicting risk from technical debt within an organization, according to embodiments. The method may be performed by the computing environment 100 of FIG. 1, for example. The method 900 may include executing processor-executable instructions (e.g., stored on the memory 104 and/or non-transitory memories) using one or more processors (e.g., the processor 102).

The method 900 may include obtaining input data including internal organization information, third-party tool information, operational risk management information, previous technical debt assessments, previous asset rationalizations, and business capability information (block 910).

The internal organization information may include detailed data concerning the technical stack, including hardware and software configurations, architectures, and technologies in use that characterize the technical aspects of the ecosystem. The internal organization information may include one or more of: code repositories, asset details, asset diagrams, or asset documents.

The third-party tool information may include one or more of: third-party asset documents, integration patterns, release and patch strategies, or data, compliance, and governance strategies such as organizational policies, procedures, compliance regulations, and best practices to ensure the technology environment aligns with internal and external governance standards.

The operational risk management information may include one or more: of operational risk categories, risk management documents, industry risk incident data and information, strategy and insights, or operational risk management reports.

The business capability information may be based upon one or more business process diagrams, business documents, business strategies, or business capability reports. The input data may serve as the foundation for the subsequent analysis, ensuring that the recommendations for asset rationalization are well-informed and relevant.

The method 900 may include processing the input data using a combination of neural networks, generative artificial intelligence models, and reinforcement learning with human feedback (block 920). This step leverages the power of AI to analyze and interpret the vast amounts of input data obtained. The use of neural networks and generative AI models allows for the classification and generation of reports used to determine technical debt, while reinforcement learning with human feedback ensures the system continuously improves its accuracy and relevance.

The method 900 may include generating the risk from technical debt (block 930) based on processing the input data. Generating the risk may include determining, classifying, and predicting potential risks from technical debt using one or more models. In at least some embodiments, generating the risk from technical debt (block 930) may include one or more of determining, via a first neural network, the risk from technical debt (e.g., the likelihood and impact of technical debt); classifying, via a second model, the risk by category; or predicting, via a third model, a potential incident from technical debt.

The method 900 may include generating an output of risk information associated with the risk from technical debt (block 940). This step makes the risk information accessible to a user of the computing environment 100. In some aspects, the risk information may be output at an electronic dashboard that includes one or more of an impact of the risk likelihood from technical debt, or a severity of the risk from technical debt. The electronic dashboard may display other suitable technical debt risk insights, may be dynamic and interactive, and/or may learn from user interactions to provide customized views for different personas within the organization.

The method 900 may include a chatbot for interactive queries related to the risks from technical debt. This chatbot may enhance the accessibility of information, allowing users to obtain insights in a conversational manner. The chatbot may leverage the data processed by the AI models to answer queries, making it a powerful tool for risk management and remediation prioritization.

The method 900 may include generating one or more notifications and/or one or more tasks associated with the risk from the existence of technical debt, and providing the one or more notifications and/or the one or more tasks to one or more cross functional teams. This proactive approach ensures that relevant teams are alerted to potential risks and can take appropriate action. For example, if a particular technical debt is identified as posing a significant risk, a task could be generated for the development team to address it, thereby mitigating the risk before it materializes into a more significant incident.

### Exemplary Language Model Architecture

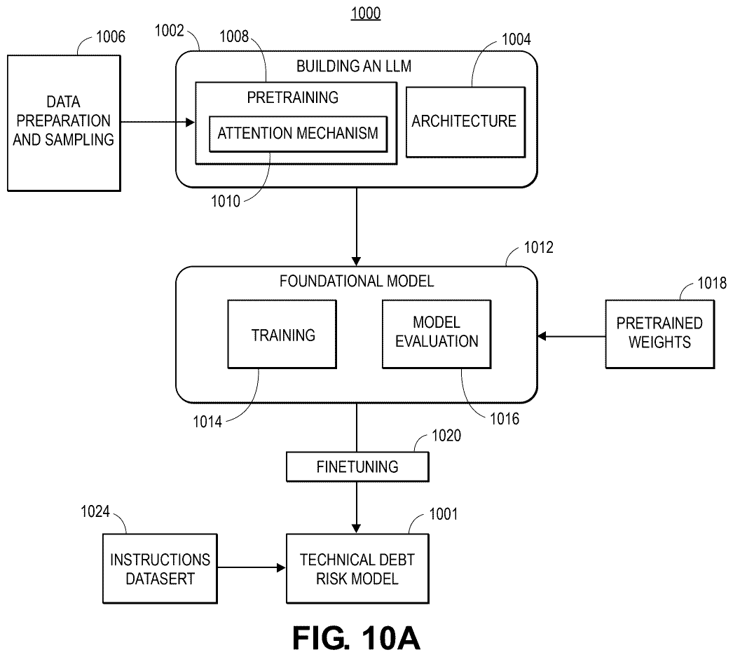

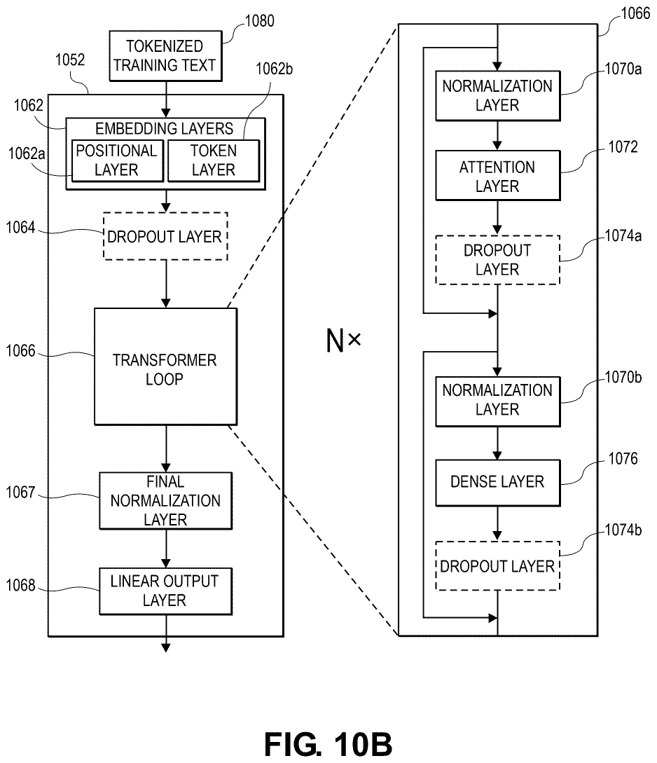

FIG. 10A depicts a block flow diagram of an example computer-implemented method 1000 for training and/or operating a language model (LM), according to embodiments. The LM may include one or more tiny, small, large language, and/or hybrid language models, and/or other suitable language model(s). The method 1000 provides a high-level overview of steps involved in setting up, training, and utilizing a language model. The method 1000 may include several components and processes, starting with data preparation and sampling (block 1006) which feeds into the pretraining section (block 1008) of building an LLM (block 1004). Within the pretraining section, there is an attention mechanism and architecture. From the pretraining, the flow moves to a foundational model (block 1010) which branches into two main components: model training (block 1014) and model evaluation (block 1012). These two components represent iterative steps in the model development, as indicated by a feedback loop from model evaluation back to pretrained weights (block 1018), wherein the evaluation may lead to adjustments in the weights used for training. Once the foundational model has been established, the process may continue with finetuning (block 1020), wherein further refinement of the model's parameters is performed to enhance its performance or adapt it to specific tasks. Finally, this refined model flows into a technical debt risk model (block 1001), influenced by an instructions dataset (block 1024), which indicates that the model's operation can be directed or influenced by specific instructions.

Training data for training in the method 1000 may encompass a wide range of information relevant to the assessment of technical debt and the risks it exposes the organization to including the likelihood of an incident with significant impact. This data serves as the foundation for the model to learn patterns, relationships, and insights that are critical for making informed decisions regarding technical debt risk and control gaps to be assessed and remediated. The training data may include historical internal organization information, third-party tool information, operational risk management information, technical debt assessments, asset rationalizations, and business capability information. The training process may involve preprocessing this data to ensure it is in a format suitable for analysis, followed by the application of machine learning techniques, including neural networks, deep learning algorithms, and reinforcement learning with human feedback.

FIG. 10B depicts a block diagram 1050 of an example neural network-based model architecture for processing and analyzing data related to technical debt risk (block 1052), according to embodiments. Tokenized training text (block 1080) is passed through preprocessing layers, specifically a data normalization layer (block 1062a) and a feature extraction layer (block 1062b). These layers are followed by a dropout layer (block 1064) to prevent overfitting. The core of the architecture is the neural network loop (block 1066), iterated N times, where N is a positive integer. Each iteration consists of a normalization layer (block 1070a), followed by an attention layer (block 1072) with its own dropout layer (block 1074a), another normalization layer (block 1070b), a dense layer (block 1076), and another dropout layer (block 1074b). The process concludes with a final normalization layer (block 1067) and a linear output layer (block 1068), producing the final output from the neural network-based model for asset rationalization.

The model architecture depicted in FIG. 10B may be used to analyze and evaluate technological debt risk, including the controls which could lead to more severe incidents. The neural network-based architecture facilitates the processing of diverse data through a series of layers and loops designed to understand and identify patterns related to technological debt risk. Initially, the input data may be processed through preprocessing layers, including normalization and feature extraction layers, which help the model understand the significance of each data point within the context of technological debt risk. This may provide an indication of the nuances of the organization's technical environment, including outdated technologies, compliance issues, and potential areas for improvement. The dropout layers introduced after the preprocessing layers and within the neural network loop serve to prevent overfitting by randomly omitting some of the units from the layers during training. A dropout layer may safeguard the model from becoming too reliant on the training data, allowing it to generalize better to new, unseen data. The neural network loop, iterated N times, is where the bulk of the analysis happens. Each iteration consists of a series of layers including normalization, attention, and dense layers, each followed by dropout layers. The normalization layers help stabilize the learning process, while the attention layers allow the model to focus on different parts of the input data to better understand the relationships between various factors contributing to technological debt and the risk likelihood or severity of an incident caused by that debt. The dense layers, on the other hand, are fully connected layers that help in learning non-linear combinations of the features. The final normalization layer ensures that the data is normalized before passing it to the linear output layer, which produces the final output of the model. The output may be used for various tasks related to the management of technological debt risk, such as generating reports on technological debt risk by applications and business functions, as discussed above. By leveraging the neural network-based architecture, the system can synthesize complex data, identify patterns, and generate actionable insights for effectively managing technological debt risk. This process is facilitated by the system's ability to learn from vast amounts of data, identify patterns, and output strategic and data-driven plans for technological debt risk management.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computing system for detecting, classifying, and predicting risk severity and/or likelihood from technical debt within an organization, the computing system comprising:
a processor; and
a memory having stored thereon computer-executable instructions that, when executed, cause the computing system to:
obtain input data including internal organization information, third-party tool information, operational risk management information, previous technical debt assessments, previous asset rationalizations, and business capability information;
process the input data using a combination of neural networks, generative artificial intelligence models, and reinforcement learning with human feedback;
generate the risk severity and/or likelihood from technical debt based on the processing; and
generate an output of risk information associated with the risk severity and/or likelihood from technical debt.

2. The computing system of claim 1, wherein the risk information is output at an electronic dashboard that includes one or more of an impact of the risk from technical debt, or a severity of the risk from technical debt.

3. The computing system of claim 1, further comprising a chatbot for interactive queries related to the risk severity and/or likelihood from technical debt.

4. The computing system of claim 1, further comprising instructions that, when executed, cause the computing system to:
generate one or more notifications and/or one or more tasks associated with the risk severity and/or likelihood from technical debt; and
provide the one or more notifications and/or the one or more tasks to one or more cross functional teams.

5. The computing system of claim 1, wherein to generate the risk from technical debt further comprises instructions that, when executed, cause the computing system to one or more of:
determine, via a first neural network, the risk from technical debt;
classify, via a second model, the risk by category; or
predict, via a third model, a potential risk from technical debt.

6. The computing system of claim 1, wherein the internal organization information includes one or more of code repositories, asset details, asset diagrams, or asset documents.

7. The computing system of claim 1, wherein the third-party tool information includes one or more of third-party asset documents, integration patterns, release and patch strategies, or data, compliance, and governance strategies.

8. The computing system of claim 1, wherein operational risk management information includes one or more of operational risk categories, risk management documents, industry risk incident data and information, strategy and insights, or operational risk management reports.

9. The computing system of claim 1, wherein the business capability information is based upon one or more business process diagrams, business documents, business strategies, or business capability reports.

10. A computer-implemented method for detecting, classifying, and predicting a risk severity and/or likelihood from technical debt within an organization, the computer-implemented method comprising:
obtaining, via one or more processors, input data including internal organization information, third-party tool information, operational risk management information, previous technical debt assessments, previous asset rationalizations, and business capability information;
processing, via a combination of neural networks, generative artificial intelligence models, and reinforcement learning with human feedback, the input data;
generating, via the one or more processors, the risk severity and/or likelihood from technical debt based on the processing; and
generating, via the one or more processors, an output of risk information associated with the risk severity and/or likelihood from technical debt.

11. The computer-implemented method of claim 10, wherein the risk information is output at an electronic dashboard that includes one or more of an impact of the risk from technical debt, or a severity of the risk from technical debt.

12. The computer-implemented method of claim 10, further comprising a chatbot for interactive queries related to the risk severity and/or likelihood from technical debt.

13. The computer-implemented method of claim 10, further comprising:
generating, via the one or more processors, one or more notifications and/or one or more tasks associated with the risk from technical debt; and
providing, via the one or more processors, the one or more notifications and/or the one or more tasks to one or more cross functional teams.

14. The computer-implemented method of claim 10, wherein generating the risk from technical debt further comprises:
determining, via a first neural network, the risk from technical debt;
classifying, via a second model, the risk by category; or
predicting, via a third model, a potential risk from technical debt.

15. The computer-implemented method of claim 10, wherein the internal organization information includes one or more of code repositories, asset details, asset diagrams, or asset documents.

16. The computer-implemented method of claim 10, wherein the third-party tool information includes one or more of third-party asset documents, integration patterns, release and patch strategies, or data, compliance, and governance strategies.

17. The computer-implemented method of claim 10, wherein operational risk management information includes one or more of the operational risk categories, risk management documents, industry risk incident data and information, strategy and insights, or operational risk management reports.

18. The computer-implemented method of claim 10, wherein the business capability information is based upon one or more business process diagrams, business documents, business strategies, or business capability reports.

19. A non-transitory computer-readable medium having stored thereon instructions that when executed by one or more processors, cause the one or more processors to:
obtain input data including internal organization information, third-party tool information, operational risk management information, previous technical debt assessments, previous asset rationalizations, and business capability information;
process the input data using a combination of neural networks, generative artificial intelligence models, and reinforcement learning with human feedback;
generate a risk severity and/or likelihood from technical debt based on the processing; and
generate an output of risk information associated with the risk severity and/or likelihood from technical debt.

20. The non-transitory computer-readable medium of claim 19, further comprising instructions that when executed by one or more processors, cause the one or more processors to:
determine, via a first neural network, the risk from technical debt;
classify, via a second model, the risk by category; or
predict, via a third model, a potential risk from technical.
